(19) United States
(12) Patent Application Publication
(10) Pub. No.: US 2008/0186155 A1
(43) Pub. Date: Aug. 7, 2008

(54) Persistence of Vision Display

(75) Inventors: John D. Spencer, Allende, MI (US); Richard J. Chutorash, Oakland Township, MI (US); Steven L. Geerlings, Holland, MI (US); Jeffrey Golden, Holland, MI (US); Michael J. Sims, Zeeland, MI (US); Rodger W. Eich, Holland, MI (US)

Correspondence Address: FOLEY & LARDNER LLP, 777 EAST WISCONSIN AVENUE, MILWAUKEE, WI, 53202-5306, US

(73) Assignee: JOHNSON CONTROLS TECHNOLOGY COMPANY

(21) Appl. No.: 11/883,752

(22) PCT Filed: Feb. 6, 2006
(86) PCT No.: PCT/US2006/004030

§ 371 Date: Aug. 6, 2007

Related U.S. Application Data
(60) Provisional application No. 60/650,205, filed on Feb. 4, 2005.

(51) Int. Cl. G09F 9/33; G02B 27/22; B60K 35/00; H04N 13/00

(52) U.S. Cl. 340/438; 340/815.45

(57) ABSTRACT

An instrument cluster includes a display using persistence of vision. The display includes a moving portion and light sources carried by the moving portion. The persistence of vision effect gives the display a resolution that is greater than the number of light sources carried by the moving portion. The display may be connected to a vehicle bus such that it can communicate with sensors and other devices connected to the vehicle bus.

### CROSS-REFERENCE TO RELATED PATENT APPLICATIONS

The present Application claims the benefit of priority of U.S. Provisional Patent Application No. 60/650,205 entitled, “Persistence of Vision Display” which is commonly assigned and herein incorporated by reference in its entirety.

### BACKGROUND

The present inventions relates generally to the field of information displays.

Typical displays use tick marks and/or icons printed on an appliqué to display information. The tick marks are usually used in cooperation with a pointer to display information such as vehicle speed, fuel level, rotations per minute of the engine, etc. Icons are typically used to give a user warnings of conditions to be brought to the user's attention. These displays often use backlighting to illuminate the display. Such displays are fixed at the time of manufacture.

A variety of devices and/or methods exist for displaying information or images. Such devices and/or methods include liquid crystal displays (LCDs); plasma and fluorescent gas discharge screens; electro-luminescent displays; light emitting diodes (LEDs); cathode ray tubes (CRTs); and projection devices such as laser scanners and light valve projectors. Other devices include signs formed of incandescent lamp matrices and large area liquid crystal polymeric dispersion thin films.

Some novelty items use an effect known as persistence of vision to display information using fewer points of light than the resolution of the displayed information. These devices rely on the phenomena that the human eye will continue to see a point of light, a spot, for a brief time after it is no longer at that point. If repeated frequently, the spot will appear to be in that location continuously.

### SUMMARY

In one embodiment, a vehicle instrument cluster having a display which comprises a moving portion is provided. Light sources are carried by the moving portion and the display generates a resolution that is greater than the number of light sources.

In another embodiment, a display comprises light sources configured to move with respect to the display. The display generates a resolution that is greater than the number of light sources. A control circuit is configured to control operation of the light sources and the display uses persistence of vision to form an image.

In another embodiment, a method of increasing the resolution of a display without adding light sources to a plurality of light sources comprises: providing a pattern for arranging the plurality of light sources with respect to the display; illuminating the plurality of light sources; and moving light sources with respect to the display in a manner to increase the overall resolution of the display.

### BRIEF DESCRIPTION OF THE DRAWINGS

FIG. 1A is a front schematic view of a display according to one embodiment that uses persistence of vision to display information;

FIG. 1B is a rear schematic view of the display of FIG. 1A;

FIG. 1C is a side schematic view of the display of FIG. 1A;

FIG. 2 is a front schematic view of a display according to another embodiment that uses persistence of vision to display information;

FIG. 3A is a front schematic view of a display according to another embodiment that uses persistence of vision to display information;

FIG. 3B is a side schematic view of the display of FIG. 3A;

FIG. 3C is a side schematic view of a display according to another embodiment that uses persistence of vision to display information;

FIG. 4 is a side schematic view of a display according to another embodiment that uses persistence of vision to display information;

FIG. 5 is an expanded view of an instrument cluster for a vehicle incorporating a display that uses persistence of vision to display information.

FIGS. 6A-B illustrate an instrument cluster for a vehicle having a tick mark that which varies with size.

### DETAILED DESCRIPTION OF EXEMPLARY EMBODIMENTS

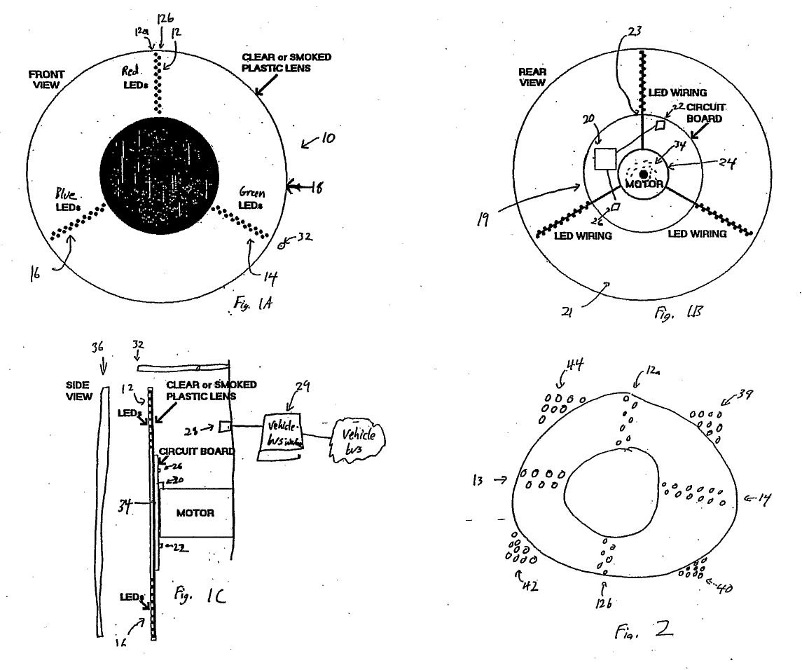

Referring to FIGS. 1A-C, an exemplary display 10 for use in an instrument cluster includes a plurality of light sources 12, 14, 16. According to some embodiments, light sources 12-16 may be LEDs. Light sources 12, 14, 16 may be the same color or different colors. In some embodiments, light sources 12-16 include red, green, and blue light sources or some other combination of light sources capable of forming a range of colors (e.g. a broad yellow and a blue may combine to form multiple colors, including ones that appear substantially white). For example, light sources 12 may emit red light, light sources 14 may emit green light, and light sources 16 may emit blue light. Light sources 12-16 may be mounted on a visible face of circuit carrying element 18 such as a printed circuit board 19, a board 21 carrying wiring 23, a conductive foil, and/or some other circuit carrying element.

A control circuit 20 may be mounted on an non-visible face of circuit carrying element 18. Control circuit 20 may include a microprocessor. Control circuit 20 may also be mounted on the same face as light sources 12-16, but may be hidden by a body. Control circuit 20 maybe configured to control operation of light sources 12-16. For example, control circuit 20 may selectively control the activation of the light sources to take advantage of the persistence of vision effect. Control circuit 20 may control light sources 12-16 to display information based on data operated on by a control program of a microprocessor.

Control circuit 20 and light sources 12-16 may be mounted on a common circuit carrying element 18, or may be mounted on separate elements. For instance, control circuit 20 may be mounted on a circuit board 19 while light sources 12-16 may be mounted on a lens. The lens may be plastic and may be clear or may have a smoked appearance. Circuit board 19 may be mounted on lens 21. Also, circuit board 19 may be substantially opaque.

Circuit carrying element 18 may be coupled to a motor 24 such that circuit carrying element 18 may be moved by motor 24. Motor 24 may be configured to rotate circuit carrying element 18. Alternately, other forms of movement may be imparted to circuit carrying element such as oscillating, waving, etc.

Control circuit 20 may be connected to a sensor 22 that relays information relating to a position of the light sources. For instance, the solid side 8 of display 10 may include spaced tick marks and a sensor may be used to detect the crossing of the tick marks. Alternatively, other types of sensors may be used to relay information relating to the positions where light from the light sources is visible to a user. Control circuit 20 may be configured to control operation of the light sources 12-16 based on the position of the moving portion 6.

If control circuit 20 is on a moving portion of display 10, it may be coupled to a receiver 26 configured to receive information transmitted by a transmitter 28. Transmitter 28 may be coupled to a communication interface circuit 29 configured to receive information from and/or transmit information to a vehicle bus 30. Transmitter 28 may also be configured to transmit commands from a user input device 32. Transmitter 28 and receiver 26 may communicate information using light, radio frequencies, electrical connection, etc. For example, transmitter 28 may include an infrared light source (e.g. an LED) and receiver 26 may include an infrared light sensor. As another example, transmitter 28 may be an RF transmitter and receiver 26 may be a radio frequency receiver. As still another example, transmitter 28 may transmit data to receiver 26 using a contact and bushing or other type of non-fixed electrical coupling. If two-way communication is desired between the solid side and the rotating portion of the display system, transmitter 28 and receiver 26 may each be transceivers.

In the illustrated embodiment, light sources 12-16 are placed in three groups of two columns each. The two columns 12a, 12b of light sources 12 are staggered. This staggered arrangement may allow a higher resolution display to be formed in a smaller space; while light sources such as LEDs may need to be spaced apart from each other, the LEDs in one column may be arranged to illuminate in the spaces between LEDs of another column. In some embodiments, the light sources of column 12a emit the same color as the light sources of column 12b. Control circuit 20 may be configured to control the light sources of columns 12a and 12b such that it appears that these light sources form a single column.

Display 10 may also include a power transfer system 34 to transfer power from a solid side 8 of the display to a moving portion 6 of the display. If the moving portion 6 rotates, display 12 may include brushings to make contact with a conductive portion which cooperate to transfer power. The communicating brushings may be composed of a metal, carbon or other comparable composite. The electrical connection to the rotating assembly is accomplished by two communicating brushings maintaining a sliding connection with each other. Display 10 may also be configured to use an inductor to transfer power from the solid side to the rotating side. If display 10 uses an oscillating arm, a wire may be used to transfer power from the solid side to the oscillating portion. Of course, any other system may be used to transfer power from the solid side 6 to the moving portion 6 of the display 10.

In an alternative embodiment, inductive coupling is utilized to transfer power and communications between the rotating and non-rotating parts. A primary inductor (coupled to the non-rotating parts) creates a magnetic field that expands and collapses. The secondary winding (coupled to the rotating parts) has a current induced therein due to a change in the magnetic filed created by the primary inductor. The amplitude and/or frequency of the energy that is coupled may be modulated to create two way communications. The load may be varied on the secondary (rotating) side of the inductor which would be detected on the primary (stationary) side.

Display 10 may also include a cover 36 that covers display 10. Cover 36 may selectively hide display 10. For example, cover 10 may comprise a transparent mirror which reflects light from within the vehicle when the display is off, but which allows light from light sources 12-16 to shine through when illuminated. As another example, cover 36 may include a loosely knit fabric which allows light from light sources 12-16 to shine through when illuminated.

Light sources 12-16 may be configured to extend essentially from the pivot point of display 10 (e.g. the center of rotation of a rotating member). Alternatively, as illustrated, light sources 12-16 may be located a distance from the pivot point of display 10. For example, the light sources may be located such that they form a band close to the perimeter of the moving portion.

Referring to FIG. 2, display 10 may be designed to output information, in some or all modes, in a display areas that appears rectangular. For example, display 10 may include auxiliary light sources 38, 40, 42, 44 which may be positioned to make a circular display 10 appear rectangular. Also, light sources 12-16 could be controlled by control circuit 20 such that the display area appears as a box or rectangle that is inscribed within the radius of a rotating member.

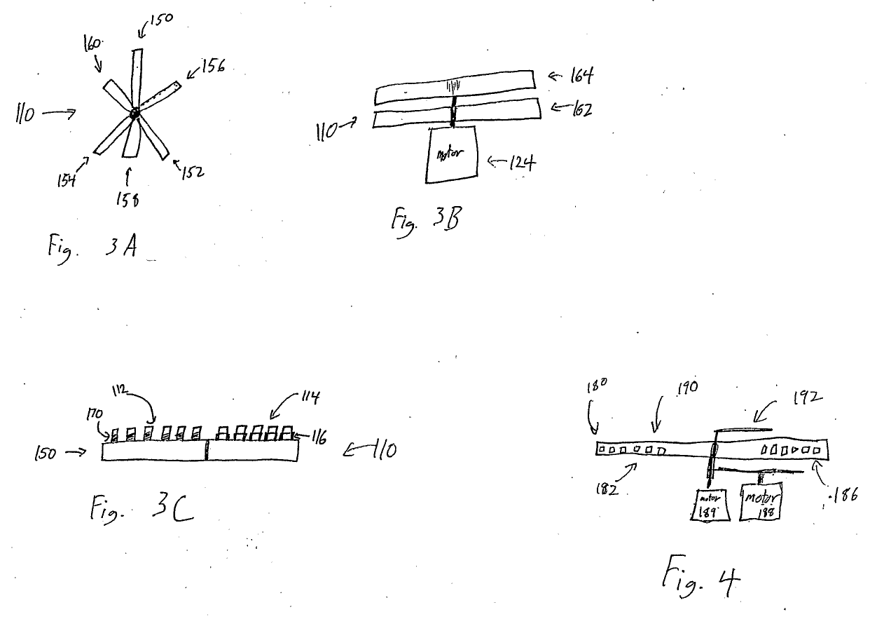

Referring to FIGS. 3A-C, display 10 may be configured such that it has light sources 112-116 on multiple levels. Light sources 112-116 may be controlled in a manner configured to give a three dimensional effect to information displayed by display 10. For example, light sources 112-116 may be controlled such that tick marks would appear to taper. As another example, tick marks or other information normally found on an applique may be displayed on a first level and the display may be used to recreate a pointer at a second level that is in front of the first level. Tick marks may vary in size as shown in the illustrative exemplary embodiments of FIGS. 6A-B. The lighting sequence of the light sources may vary as the lighting sources move to generate a tick mark of greater or lesser dimensions. Moreover, as shown in the illustrative embodiments, the size of the tick marks may vary with the location of the pointer 192.

Referring to FIGS. 3A & 3B, the levels may be created by mounting the light sources 112-116 on multiple rotating members 150-160 where the members 156-160 towards the front of the display 10 do not block the view of the light sources mounted on the rotating members 150-154 located towards the back of the display 10 (e.g. they consist of arms carrying the light sources and/or are composed essentially of transparent—including translucent—materials). Display 10 may comprise a plurality of arms 150-154 at a first level 162 and a plurality of arms 156-160 at a second level 164 in front of the first level. Both levels 162, 164 of arms may be rotated by a common motor. Further, the arms in the back level 162 could, instead, be replaced by a solid disk.

Referring to FIG. 3C, as another option, the light sources 112-116 maybe designed to be mounted different distances off of a common rotating member 150 (e.g. by using different length lead wires and/or using spacers 170). Light sources 112-114 would be mounted such that they were at a different level than light sources 116. If spacers 170 are used, a separate spacer 170 may be used for each light source. Alternatively, a single spacer may be used for an entire column. Of course, other arrangements are possible as well.

Referring to FIG. 4, display 180 may include a pointer 192 that is configured to cooperate with light sources 182-186 to display information. For example, light sources 182-186 may be configured to display tick marks and indicia that are configured to display vehicle related parameter information (fuel level indicators, rpm indicators, speed indicators, etc.). These tick marks and/or indicia may be used to mimic a traditional instrument cluster gage. Pointer 192 may then be controlled to go to a particular position based on information relating to the parameter being displayed by light sources 182-186. Moving portion 190 may be controlled by motor 188 while pointer 192 is controlled by motor 189 (which may be, for example, a stepper motor).

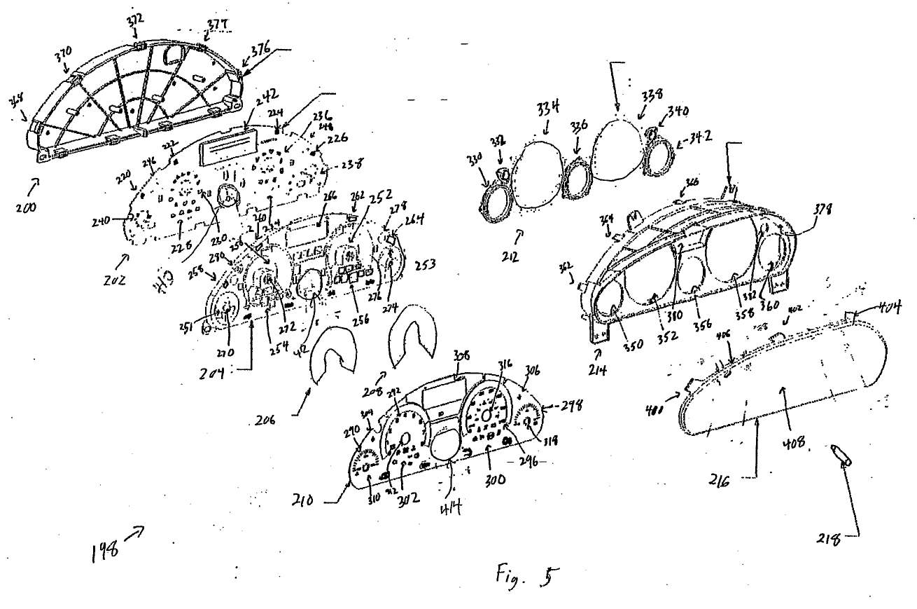

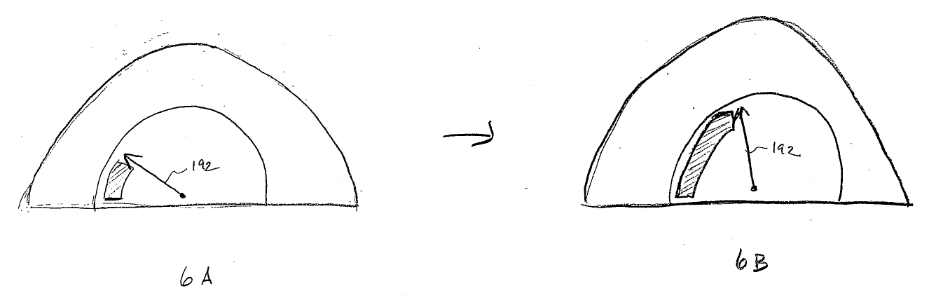

Referring to FIG. 5, instrument cluster 198 may or may not include any number of other traditional or untraditional features of instrument clusters in addition to a persistence-of-vision-based display 410. The motor of display 410 may be mounted on circuit board 202 such that display 410 is visible through (and may partially extend through spaces 412, 414, 336, and 356. One of spaces 412, 414, 335, and 356 may be configured to be covered by a cover 36 such that display 410 is not easily viewable when it is not illuminated. Instrument cluster 198 may also include more than one display based on persistence of vision.

Instrument cluster 198 may include an applique 210 having various indicia 290-306 printed on a forward facing face of applique 210. Indicia 290-306 may include tick marks and numerical indicia 290-298, tell-tales 300, 302, and/or turn indicators 304, 306. Tick marks and numerical indicia 290-298 are illuminated by light source groups 230, 232, 236-240 (shown as LEDs) mounted on circuit board 202. Spaces 250, 250-253, 268 are provided in opaque light directing housing 204 such that light from the respective groups of light sources are directed towards the tick marks they are configured to illuminate, but do not provide significant amounts of light to other indicia on applique 210. Light diffusers 206, 208 may be used to diffuse light from light source groups 230, 236 used to illuminate tick marks and numerical indicia 292, 296. Light sources 228, 234 (shown as LEDs) mounted on circuit board 202 may also be provided, which light sources shine light through various spaces 254, 256 in opaque light directing housing 204 to selectively illuminate one or more indicia of indicia groups 302, 300 on applique 210. Light sources 246, 248 (shown as LEDs) may also be provided to illuminate turn indicators 304, 306.

Instrument cluster 198 may also include a digital display 242. Display 242 may be mounted to circuit board 202 (as shown) or may arranged in some other manner. Information from display 242 can be viewed through space 266 in opaque light directing housing 204 and space 308 in applique 210. In some embodiments, instrument cluster 198 will only have either a fixed display 242 or a persistence of vision display 410, but not both a fixed display 242 and a persistence of vision display 410.

Instrument cluster 198 may also include pointers (not shown) which extend through openings 270-276 in opaque light directing housing 204 and openings 310-318 in applique 210.

Bezel 214 may include separated spaces 350-360, 380, 382 to allow a vehicle occupant to view information from applique 210 and display 242. Bezel 214 may alternately have an open design without separated spaces. In one embodiment, bezel 214 may consist essentially of a brow and/or lip. Bezel 214 may also include connectors 362-366 which are configured to allow connection of bezel 214 to back cover 200. Back cover 200 may include corresponding connectors 368-376 which are configured to allow connection of bezel 214 to back cover 200. The connection may be a snap connection or some other type of connection.

Instrument cluster 198 may further include ring system 212 having various openings 230-342 through which information can be viewed, a stem 218 that allows user actuation of a control, and/or other additional components that may serve various other purposes.

Circuit board 202 may be a printed circuit board, may be a flexible circuit board, may be a rigid circuit board, may be a conductive foil, and/or may take some other form.

Vehicles may include aircraft, watercraft, and land vehicles. Land vehicles may include passenger vehicles such as cars, trucks, busses, sport utility vehicles, and vans.

One embodiment is directed to a display for use in an instrument cluster of a vehicle. The display includes a plurality of light sources (such as LEDs) which are controlled by a control circuit to display information using a persistence of vision effect. The display includes a moving portion on which the light sources are carried. The display also includes a circuit carrying element on which at least a portion of the control circuit is carried. Power and information are transferred from a solid side of the display to the moving portion of the display. The information may include information received from a vehicle bus of the vehicle in which the instrument cluster is mounted. The light sources may include red, green, and blue LEDs. Further, the light sources may be mounted on more than one level and may be capable of conveying a three-dimensional effect.

An additional embodiment is directed to an instrument cluster comprising a display. The display comprises a moving portion and light sources carried by the moving portion. The display has a resolution that is greater than the number of light sources.

An additional embodiment is directed to a display that includes a plurality of light sources. The display uses persistence of vision to display information and the light sources are configured such that they are capable of being illuminated to form a three-dimensional image.

An additional embodiment is directed to an instrument cluster for an automobile comprising a display. The display comprises a moving portion and light sources carried by the moving portion. The light sources are arranged in at least two columns such that light sources from a first column can illuminate spaces between light sources of a second column. In another exemplary embodiment, where it is desirable to rotate the light sources at a slower speed, light sources are arranged in two overlapping (as opposed to interlaced) columns. By overlapping the light sources, the refresh rate was doubled for a given rotational speed.

An additional embodiment is directed to an instrument cluster for an automobile comprising a display. The display comprises a moving portion and light sources carried by the moving portion. The light sources are arranged in a staggered pattern.

An additional embodiment is directed to a display. The display includes light sources, and uses a persistence of vision effect to display information using the light sources. The light sources are controlled to display tick marks.

An additional embodiment is directed to an instrument cluster for an automobile comprising a display. The display includes light sources, and uses a persistence of vision effect to display information using the light sources. The display is reconfigurable in response to a user input.

An additional embodiment is directed to an instrument cluster for an automobile comprising a display. The display includes light sources, and uses a persistence of vision effect to display information using the light sources. The display is reconfigurable in response to a predetermined event.

An additional embodiment is directed to an instrument cluster for an automobile comprising a display. The display includes light sources, and uses a persistence of vision effect to display information using the light sources. The display is configured to be connected to the vehicle bus.

A display according to one of the above-listed embodiments may include a microprocessor which may be carried by a moving portion of the display. The microprocessor may be located on a back side of the moving portion.

A display according to one of the above-listed embodiments may include a sensor coupled to the moving portion such that the sensor is configured to sense information relating to the position of the moving portion. A control circuit may be configured to control the light sources based on information received from the sensor.

In a display according to one of the above-listed embodiments, the light sources may include LEDs. A display according to one of the above-listed embodiments may include a cover or other disguising member that is capable of hiding the display when the display is not illuminated. A display according to one of the above-listed embodiments may include a member that is transparent to the light sources when they are illuminated and not transparent when the light sources are not illuminated.

A display according to one of the above-listed embodiments may be capable of displaying various types of information. The display may be capable of displaying one or more of navigation information and/or warning messages. The display may switch the type of information being displayed in response to a predetermined event and/or in response to a user input. A display according to one of the above-listed embodiments may switch the color in which information is displayed in response to a predetermined event.

A display according to one of the above-listed embodiments may include a processing circuit coupled to the display, which circuit is configured to process information from the vehicle bus and transmit the information to a control circuit of the display.

A display according to one of the above-listed embodiments may include light sources on a plurality of levels. A display according to one of the above-listed embodiments may include light sources capable of creating a three-dimensional effect. A display according to one of the above-listed embodiments may include a display where light sources on one level are used to display tick marks and/or information indicators and light sources from a second level may be used to display a pointer.

A display according to one of the above-listed embodiments may include a pointer that cooperates with the display to display information.

A display according to one of the above-listed embodiments may include a moving portion that includes a disk.

Light sources in a display according to one of the above-listed embodiments may be evenly spaced. Also, light sources in a display according to one of the above-listed embodiments may include light sources of a plurality of colors. The lights sources may include red, green, and blue light sources. The light sources may be combinable to form light that is substantially white.

A display according to one of the above-listed embodiments may be used to form a heads up display (HUD). The HUD may include a protective cover to prevent items from interfering with the display.

While shown as mounted on a disk, the light sources may be carried by any other structure. For instance, the light sources may be mounted on a projecting arm or on some other structure or combination of structures. Also, while shown as moved by a motor, any other device may be used to impart motion to the light sources. Additionally, while the illustrated motion is rotation, any other type of motion may be used to take advantage of a persistence of vision effect. Moreover, while the illustrated graphics include pointers and tick marks, the display may also be configured to generate different text, pictures and alternative graphics which may include but are not limited to road names, turn-by-turn indicators, predetermined points of interest (e.g., gas stations, restaurants, hotels, etcetera.), compass information, or other information. Also, while the columns of LEDs are shown as having a common color, LEDs of various colors can be dispersed with a single group or column. Additionally, while the light sources are shown as rotating, the light sources could be stationary and a second body could be used to control where light from the sources appears. Also, while the above described embodiments show the light from the light sources as radiating directly to a user, other bodies (such as light guides and/or fiber optics) may be used to redirect the light from the sources.

What is claimed is:

1. A vehicle instrument cluster having a display, the display comprising:
a moving portion; and
light sources carried by the moving portion;
wherein the display generates a resolution that is greater than the number of light sources.

2. The instrument cluster of claim 1, wherein the light sources are arranged in a staggered pattern, the staggered pattern configured to enable the light sources to illuminate the spaces between the light sources when the moving portion is operating.

3. The instrument cluster of claim 2, wherein the light sources are arranged in at least two columns such that the columns of the light sources define spaces there between and wherein the moving portion is configured such that light sources in a first column can illuminate spaces between light sources of a second column.

4. The instrument cluster of claim 1, wherein the moving portion rotates with respect to the display and the light sources are configured to extend from the center of rotation of the moving portion.

5. The instrument cluster of claim 1, further comprising a pointer configured to move with respect to the display.

6. The instrument cluster of claim 1, further comprising a second moving portion with light sources carried therein, wherein the second moving portion is coupled to the first moving portion and the first and second moving portions are configured to move with respect to the display so as to collectively appear as one three-dimensional member.

7. The instrument cluster of claim 1, further comprising:
a power source configured to supply power to the light sources; and
brushings configured to make contact with a conductive portion of the light sources and transfer power thereto while the light sources are moving.

8. The display of claim 1, further comprising:
a power source configured to supply power to the light sources, wherein the power source and light sources are configured to inductively transfer power there between.

9. A display comprising:
light sources configured to move with respect to the display, wherein the display generates a resolution that is greater than the number of light sources; and
a control circuit configured to control operation of the light sources;
wherein the display uses persistence of vision to form an image.

10. The display of claim 9, wherein the control circuit is configured to control the light sources to display tick marks via movement of the light sources.

11. The display of claim 9, wherein the light sources are configured to display a tick mark which varies in size.

12. The display of claim 9, wherein the light sources are configured to be able to form a three-dimensional image via movement thereof

13. The display of claim 9, wherein the control circuit is coupled to a vehicle information bus and wherein the display is reconfigurable in response to a user input.

14. The display of claim 9, wherein the control circuit is coupled to a vehicle information bus and wherein the display is reconfigurable in response to a predetermined event.

15. The display of claim 9, wherein the light sources are configured to collectively appear as one three-dimensional member when in motion.

16. The display of claim 9, further comprising:
a power source configured to supply power to the light sources; and
brushings configured to make contact with a conductive portion of the light sources and transfer power thereto while the light sources are moving.

17. The display of claim 9, further comprising:
a power source configured to supply power to the light sources, wherein the power source and light sources are configured to inductively transfer power there between.

18. A method of increasing the resolution of a display without adding light sources to a plurality of light sources, comprising:
providing a pattern for arranging the plurality of light sources with respect to the display;
illuminating the plurality of light sources; and
moving light sources with respect to the display in a manner to increase the overall resolution of the display.
